(19) United States
(12) Patent Application Publication
(10) Pub. No.: US 2018/0336506 A1
(43) Pub. Date: Nov. 22, 2018

(54) DIGITAL COMMERCE WITH CONSUMER CONTROLLED PAYMENT PART

(71) Applicant: MASTERCARD INTERNATIONAL INCORPORATED, Purchase, NY (US)

(72) Inventor: SANDEEP MALHOTRA, Greenwich, CT (US)

(21) Appl. No.: 15/597,557

(22) Filed: May 17, 2017

(51) Int. Cl. G06Q 10/06; G06Q 30/06; G06Q 20/12; G06Q 20/40

(52) U.S. Cl. CPC G06Q 10/0635; G06Q 20/40; G06Q 20/12; G06Q 30/0635

(57) ABSTRACT

An improved digital commerce transaction in which the shopping part and the payment part are separated in time, and the timing of the payment part is controlled by the consumer. A consumer completes the shopping part, checks out, and receives confirmation from the merchant that the transaction has been completed. For consumer's having a risk profile with the merchant, the merchant fulfills the order and ships the items prior to the consumer initiating the payment part. For consumer's not having a risk profile, initiation of the payment part is controlled by the consumer, at a time and place of his/her choosing. After checking-out, the consumer receives a message that includes an invoice and a link selectable by the consumer. When the consumer selects the link, he/she begins the payment part of the transaction.

### FIELD OF THE INVENTION

The present invention relates to an improvement to digital commerce shopping using a hand-held computing device.

### BACKGROUND OF THE INVENTION

Convenience and ease of access are two reasons why digital commerce continues to gain in popularity and use as a preferred way to shop. Coupled with the ubiquity of mobile devices and the continuous increase in functionality and availability of such devices, digital commerce enables consumers to shop for anything, anytime, anywhere, at the complete discretion of the consumer. Yet, as easy as the digital commerce process is, it still requires the consumer to provide certain details before a shopping experience is completed. For example, once a consumer has selected items and placed them in a virtual shopping cart, the check-out process may require the consumer to enter personal and payment information, e.g., billing address, ship-to address, credit/debit card or bank information, etc. While this part of the shopping process is the least interesting part of the entire experience, it may not be as inconvenient and cumbersome when shopping from a desk-top or laptop computer, as it is when shopping from a hand-held device, such as a mobile phone, tablet, etc., thanks to pain points associated with smaller screens and slow connections. This is the case because consumers are often unwilling to go through complex check-out processes on these screens—research shows that over half of cart abandonments occur at the payment stage, and others happen at address entry points or check-out login. Consider, for example, a consumer traveling in the back seat of a cab who, at that moment, has a great idea for gift for a friend. The consumer can quickly shop for and locate the gift using his/her smartphone, and begin the process to purchase the item. However, entry of the personal and payment information during check-out is inconvenient using a hand-held device in this and other situations. If the consumer does not complete the transaction by providing the required information, the items he/she selected and placed in the shopping cart will likely not be held for the consumer. In addition, it is challenging for a merchant to provide a display suitable for handheld devices that facilitates the payment process and makes it easier and more convenient for the consumer. Also, as new payment methods (such as electronic mobile wallets, prepaid cards, bank account debits) are introduced, the real estate on the handheld device becomes crowded and results in poor consumer experience. Merchants also need to invest time and money in complex integration systems to accept new payment methods.

Thus, there exists a need for a solution to the above-identified shortcomings of the prior art.

### SUMMARY OF THE INVENTION

The present invention is directed to an improved system and method for digital commerce using mobile electronic or handheld computing devices. The digital commerce experience typically involves a shopping part, during which a consumer selects an item to purchase from a merchant website, and a payment part, during which the purchase is authorized and the merchant is paid. During the shopping part, the consumer selects one or more items and places them in a virtual shopping cart. Once finished shopping, the consumer proceeds to check-out and begins a payment part of the digital commerce process. The payment part comprises an authorization part, during which the purchase of the items selected by the consumer is authorized, and a clearing and settlement part, during which the merchant is paid for the items. During the authorization part a determination is made as to whether the consumer has sufficient credit or funds for the transaction, among other determinations. If the transaction is authorized, payment to the merchant for the transaction is facilitated. Typically, authorization and payment are serial processes carried-out in real-time

In accordance with an embodiment of the present invention, the shopping part and the payment part of a digital commerce transaction are separated in time, and the timing of the payment part is controlled by the consumer. A consumer completes the shopping part, checks out, and receives confirmation from the merchant that the transaction has been completed and that the items purchased by the consumer are being shipped prior to the consumer completing the payment part (i.e., with the consumer having only completed the shopping part). Thus, the merchant ships the items upon completion of the shopping part, according to an embodiment of the present invention. After checking-out, the consumer receives from the merchant a notification (such as SMS, e-mail, or “push” message) that includes an invoice for the transaction and a link selectable by the consumer for completing the transaction. When the consumer selects the link, he/she begins the payment process comprising an authorization part, during which the transaction is authorized by the issuer, and a clearing and settlement part, during which payment is made to the merchant.

In addition to separating the shopping part from payment part, the present invention simplifies the merchant part of the transaction by allowing a payments gateway or payment service provider to serve the different payment methods in the payment part to the consumer without the merchant site having to integrate with each and every payment method. This allows a merchant to accept a wide variety of payment options provided by a payments gateway or payment service provider without having to spend the time and/or incur the cost to incorporate each and every payment option in the merchant web site. When a consumer clicks on the link in the notification in the payment part, it brings a set of payment options offered by a payment service provider or a payments gateway, obviating the need for the merchant to integrate with every electronic/mobile wallet, direct bank account, card type, etc. This aspect of the present invention provides consumers and merchants with a broad range of payment options without any additional cost or effort by the merchant, resulting in higher sales and a better consumer experience.

As noted, the consumer decides when to complete the transaction, while, in accordance with this embodiment, the merchant ships the items prior to receiving authorization or payment. In this embodiment, the merchant has a risk profile associated with the consumer that enables the merchant to assess the risk associated with fulfilling an order prior to completing the payment part. The consumer risk profile may be based upon past transactions between the merchant and consumer, transactions between the consumer and other similar merchants, transactions by the consumer with a certain issuer, transactions by the consumer over a certain electronic transaction network, and/or other factors useful for evaluating a consumer's risk of non-payment, such as scoring leveraging consortium data. Thus, the present invention enables a merchant to ship items without waiting for completion of the payment part, but also with assurance of being paid for the transaction resulting in better conversions and higher sales. This also benefits the consumer, who now has access to a simpler and easier digital commerce experience.

In accordance with an alternative embodiment, the merchant does not ship the items until completion of the payment part, the timing of which is still controlled by the consumer. In this embodiment, the merchant sends a message to the consumer after the consumer checks-out. The message includes an invoice for the transaction and a link selectable by the consumer for completing the transaction. When the consumer selects the link, he/she begins the payment part. Although the merchant does not ship the items until completion of at least the authorization part, this embodiment of the present invention still simplifies the digital commerce transaction using a mobile or handheld computing device by eliminating the requirement that the consumer enter payment and personal information to complete the transaction. Although, the digital commerce transaction is not technically complete when referring to such transactions, this embodiment of the present invention nevertheless enables the consumer to shop quickly and easily using a mobile device or other handheld computing device, and then complete the transaction at a time and place more convenient to the consumer.

Embodiments of the present invention thus provide an improved digital commerce transaction using a mobile or handheld computing device that decouples the shopping part of the transaction and the payment part of the transaction—importantly placing control over the latter with the consumer. In one embodiment, the shopping part is completed, the order fulfilled, and the items shipped by the merchant prior to initiation (let alone completion) of the payment part by the consumer. In another embodiment, the shopping part is completed, the order is fulfilled and the items shipped after completion of at least the authorization part of the payment part. Importantly, control over initiation of the payment part is with the consumer.

An embodiment of the present invention is directed to a system for an improved electronic transaction between a consumer and a merchant over an electronic transaction network. The electronic transaction includes a shopping part into which the consumer selects at least one item to purchase from the merchant and from which the merchant creates an order for the electronic transaction, and a payment part initiable by the consumer temporally separate from the shopping part. The system comprises a merchant server connectable to the electronic transaction network and having a consumer risk profile stored in memory of the merchant server. The server also has a processor operable by a program of instructions stored in memory of the merchant server that causes the merchant server processor to, prior to consumer initiation of the payment part: determine, based upon the consumer risk profile, whether to fulfill the order and ship the at least one item prior to customer initiation of the payment part; transmit the order to an acquirer server; and transmit an invoice for the order to the consumer, the invoice containing a link selectable by the consumer for consumer initiation of the payment part. The system further comprises an issuer server connectable to the electronic transaction network and having a processor operable by a program of instructions stored in memory of the issuer server that causes the issuer server processor to, in response to consumer initiation of the payment part: receive the order; determine whether to approve the order; and transmit the determination to a transaction network server.

An embodiment of the present invention is further directed to a system for an improved electronic transaction between a consumer and a merchant over an electronic transaction network, wherein the program of instructions, when executed by the issuer server processor, further causes the issuer server processor to, in response to consumer initiation of the payment part: receive a request for payment of the order from the transaction network server; determine a payment amount; and transmit the payment amount to the transaction network server for transmission to the merchant for the electronic transaction.

An embodiment of the present invention is further directed to a system for an improved electronic transaction between a consumer and a merchant over an electronic transaction network, wherein the consumer risk profile is based upon historical shopping data for electronic transactions between the consumer and the merchant.

An embodiment of the present invention is further directed to a system for an improved electronic transaction between a consumer and a merchant over an electronic transaction network, wherein the consumer risk profile is based upon historical shopping data for electronic transactions between the merchant and one or more consumers.

An embodiment of the present invention is further directed to a system for an improved electronic transaction between a consumer and a merchant over an electronic transaction network, wherein the consumer risk profile is based upon a geographic location of one of the merchant and the consumer.

An embodiment of the present invention is further directed to a system for an improved electronic transaction between a consumer and a merchant over an electronic transaction network, wherein the order contains at least one of a merchant identifier, an order identifier, an item identifier, a transaction amount and a ship-to address.

An embodiment of the present invention is further directed to a system for an improved electronic transaction between a consumer and a merchant over an electronic transaction network, wherein consumer selection of the link in the invoice causes initiation of the payment part, wherein the system further comprises an acquirer server having a processor operable by a program of instructions stored in memory of the acquirer server that causes the acquirer server processor to, in response to consumer selection of the link and initiation of the payment part, provide a payment option web page to the consumer having a plurality of payment options selectable by the consumer.

An embodiment of the present invention is further directed to a system for an improved electronic transaction between a consumer and a merchant over an electronic transaction network, wherein the program of instructions, when executed by the acquirer server processor, further causes the acquirer server processor to, in response to consumer selection of one of the plurality of payment options, transmit an authorization request to the issuer server.

An embodiment of the present invention is further directed to a system for an improved electronic transaction between a consumer and a merchant over an electronic transaction network, wherein the program of instructions, when executed by the acquirer server processor, further causes the acquirer server processor to, in response to consumer selection of one of the plurality of payment options, transmit a payment request to the issuer server.

An embodiment of the present invention is further directed to a system for an improved electronic transaction between a consumer and a merchant over an electronic transaction network, wherein the program of instructions, when executed by the acquirer server processor, further causes the acquirer server processor to, in response to consumer selection of one of the plurality of payment options, transmit an authorization request and a payment request to the issuer server.

A second embodiment of the present invention is directed to a system for an improved electronic transaction between a consumer and a merchant over an electronic transaction network, the electronic transaction having a shopping part during which the consumer selects at least one item to purchase from the merchant and during which the merchant creates an order for the electronic transaction, and a payment part initiable by the consumer temporally separate from the shopping part. A merchant server, an issuer server and an acquirer server being connectable to the electronic transaction network. The system comprising a transaction network server having a processor operable by a program of instructions stored in memory of the transaction network server that causes the transaction network server processor to, in response to consumer initiation of the payment part by selection of a link in an invoice received by the consumer from the merchant server: receive the invoice from the acquirer server; transmit the invoice to the issuer server; receive a determination from the issuer server of whether to approve the invoice; transmit the determination to the acquirer server; receive a request for payment of the invoice of a payment amount from the issuer server; and transmit the payment amount to the acquirer server for transmission to the merchant server.

A third embodiment of the present invention is directed to a method for improving an electronic transaction between a consumer and a merchant over an electronic transaction network, the electronic transaction having a shopping part during which the consumer selects at least one item to purchase from the merchant and during which the merchant creates an order for the electronic transaction, and a payment part initiable by the consumer temporally separate from the shopping part. The method comprises, prior to consumer initiation of the payment part and by a merchant server connectable to the electronic transaction network and having a consumer risk profile stored in memory of the merchant server: determining, based upon the consumer risk profile, whether to fulfill the order and ship the at least one item prior to customer initiation of the payment part; transmitting the order to an acquirer server; and transmitting an invoice for the order to the consumer, the invoice containing a link selectable by the consumer for consumer initiation of the payment part. The method further comprises, in response to consumer initiation of the payment part and by an issuer server connectable to the electronic transaction network: receiving the order; determining whether to approve the order; and transmitting the determination to a transaction network server.

A third embodiment of the present invention is further directed to a method for improving an electronic transaction between a consumer and a merchant over an electronic transaction network, the method further comprising, in response to consumer initiation of the payment part and by the issuer server: receiving a request for payment of the order from the transaction network server; determining a payment amount; and transmitting the payment amount to the transaction network server for transmission to the merchant for the electronic transaction.

A third embodiment of the present invention is further directed to a method for improving an electronic transaction between a consumer and a merchant over an electronic transaction network, wherein the consumer risk profile is based upon historical shopping data for electronic transactions between the consumer and the merchant.

A third embodiment of the present invention is further directed to a method for improving an electronic transaction between a consumer and a merchant over an electronic transaction network, wherein the consumer risk profile is based upon historical shopping data for electronic transactions between the merchant and one or more consumers.

A third embodiment of the present invention is further directed to a method for improving an electronic transaction between a consumer and a merchant over an electronic transaction network, wherein the consumer risk profile is based upon a geographic location of one of the merchant and the consumer.

A third embodiment of the present invention is further directed to a method for improving an electronic transaction between a consumer and a merchant over an electronic transaction network, wherein the order contains at least one of a merchant identifier, an order identifier, an item identifier, a transaction amount and a ship-to address.

A third embodiment of the present invention is further directed to a method for improving an electronic transaction between a consumer and a merchant over an electronic transaction network, wherein consumer selection of the link in the invoice causes initiation of the payment part, wherein the method further comprises, in response to consumer selection of the link and initiation of the payment part and by an acquirer server, providing a payment option web page to the consumer having a plurality of payment options selectable by the consumer.

A third embodiment of the present invention is further directed to a method for improving an electronic transaction between a consumer and a merchant over an electronic transaction network, wherein the method further comprises, in response to consumer selection of one of the plurality of payment options and by the acquirer server, transmitting an authorization request to the issuer server.

A third embodiment of the present invention is further directed to a method for improving an electronic transaction between a consumer and a merchant over an electronic transaction network, wherein the method further comprises, in response to consumer selection of one of the plurality of payment options and by the acquirer server, transmitting a payment request to the issuer server.

A third embodiment of the present invention is further directed to a method for improving an electronic transaction between a consumer and a merchant over an electronic transaction network, wherein the method further comprises, in response to consumer selection of one of the plurality of payment options and by the acquirer server, transmitting an authorization request and a payment request to the issuer server.

A fourth embodiment of the present invention is directed to a method for an improving an electronic transaction between a consumer and a merchant over an electronic transaction network, the electronic transaction having a shopping part during which the consumer selects at least one item to purchase from the merchant and during which the merchant creates an order for the electronic transaction, and a payment part initiable by the consumer temporally separate from the shopping part. The method comprises, in response to consumer initiation of the payment part by consumer selection of a link in an invoice for the order and by a transaction network server in the electronic transaction network: receiving the invoice from an acquirer server; transmitting the invoice to an issuer server; receiving a determination from the issuer server of whether to approve the invoice; transmitting the determination to the acquirer server; receiving a request for payment of the invoice of a payment amount from the issuer server; and transmitting the payment amount to the acquirer server for transmission to the merchant server.

### DESCRIPTION OF THE DRAWINGS

Embodiments of the present invention will now be described with reference to the following figures, wherein:

FIG. 1 depicts a block diagram of shopping, authorization and fulfillment parts of a prior art digital commerce transaction;

FIG. 2 depicts a block diagram of clearance and payment parts of a prior art digital commerce transaction;

FIG. 3 depicts a block diagram of shopping and fulfillment parts of a digital commerce transaction in accordance with embodiments of the present invention;

FIG. 4 depicts a block diagram of an authorization part of a payment part of a digital commerce transaction in accordance with embodiments of the present invention;

FIG. 5 depicts a block diagram of a clearing and settlement parts of a payment part of a digital commerce transaction in accordance with embodiments of the present invention;

FIG. 6A is a flow diagram of part of a digital commerce transaction in accordance with embodiments of the present invention;

FIG. 6B is a flow diagram of part of a digital commerce transaction in accordance with embodiments of the present invention; and

FIG. 7 is a block-diagram schematic of a server in accordance with embodiments of the present invention.

### DESCRIPTION OF EMBODIMENTS OF THE INVENTION

As used herein, the term “connectable” refers to various states of connection between electronic devices. For example, “connectable” refers to a physical connection between electronic devices, a wireless connection between electronic devices, a combination of a physical and wireless connection between electronic devices, a transient or episodic connection between electronic devices. As used herein the term “connectable” also refers to various states of connectivity between electronic devices such as, by way of non-limiting example, when electronic devices are not connected, when electronic devices are connecting or disconnecting, and when electronic devices are connected.

As used herein, the term “acquirer” refers to bank that processes and settles a merchant's payment card transactions, and then in turn settles those transactions with the card issuer. Merchants maintain accounts with acquirers to ensure the merchants receive payment for cashless transactions. An acquirer may function as payment gateway that provides a merchant service to authorize cashless transactions. The payment gateway may be provided by a bank to its customers, but can be provided by a specialized financial service provider as a separate service.

As used herein, the term “issuer” refers to a financial institution, bank, credit union or company that issues cashless transaction cards to consumers. As used herein the term “cashless transaction” refers to a transaction between a user using a cashless transaction card, e.g., credit card, debit card, gift card, etc., a merchant, and an issuer of the cashless transaction card.

In accordance with an embodiment of the present invention, digital commerce is made easier by decoupling the shopping part and authorization for the transaction as a prerequisite to a merchant fulfilling an order and shipping the items purchased. In accordance with another embodiment of the present invention, a digital commerce transaction is simplified by decoupling the shopping part and the payment part. In both embodiments, the consumer has control over when and where to complete the transaction. A consumer can now shop on-line more quickly and easily, complete an order, and receive confirmation from a merchant that the order will be fulfilled and shipped without the consumer having to enter personal and payment information. The present invention enables such a streamlined and improved process by transferring control to the consumer over when the payment part of the digital commerce transaction is begun, and by enabling the merchant to fulfill the order with confidence of being paid.

In a first embodiment, the present invention transfers control to the consumer for when the payment part of the digital commerce process is begun. However, the merchant fulfills the order and ships the items prior to the transaction being authorized. The consumer maintains control over when the payment part of the process is begun, and is thus able to complete the transaction at the consumer's convenience. For the merchant to accept the risk of shipping product prior to receiving authorization of payment, a merchant builds a risk profile for each consumer that enables the merchant to assess the risk associated with fulfilling an order prior to completing the payment part. The consumer risk profile may be based upon past transactions between the merchant and consumer, transactions between the consumer and other similar merchants, transactions by the consumer with a certain issuer, transactions by the consumer over a certain electronic transaction network, and/or other factors useful for evaluating a consumer's risk of non-payment. Each transaction entered into by a consumer will be evaluated by the merchant based upon the consumer's risk profile. The merchant is thus able to assess the risk of fulfilling the order prior to receiving authorization, and the coincident risk of not being paid. Consumers may develop a favorable risk profile by repeated purchases from a merchant or through a particular electronic transaction network. These consumers are essentially provided preferential treatment by a merchant because of a favorable history of purchases and payments by the consumer to the merchant.

In an alternative embodiment, the present invention transfers control to the consumer for when the payment part of the digital commerce process is begun, but in this embodiment the merchant will not fulfill the order and ship the items at least until the transaction is authorized. This embodiment still provides an improved and streamlined digital commerce process that eliminates the requirement for the consumer to enter personal and payment information while shopping. As with the previously described embodiment, the consumer maintains control over when the payment part of the process is begun, and is thus able to complete the transaction at the consumer's convenience.

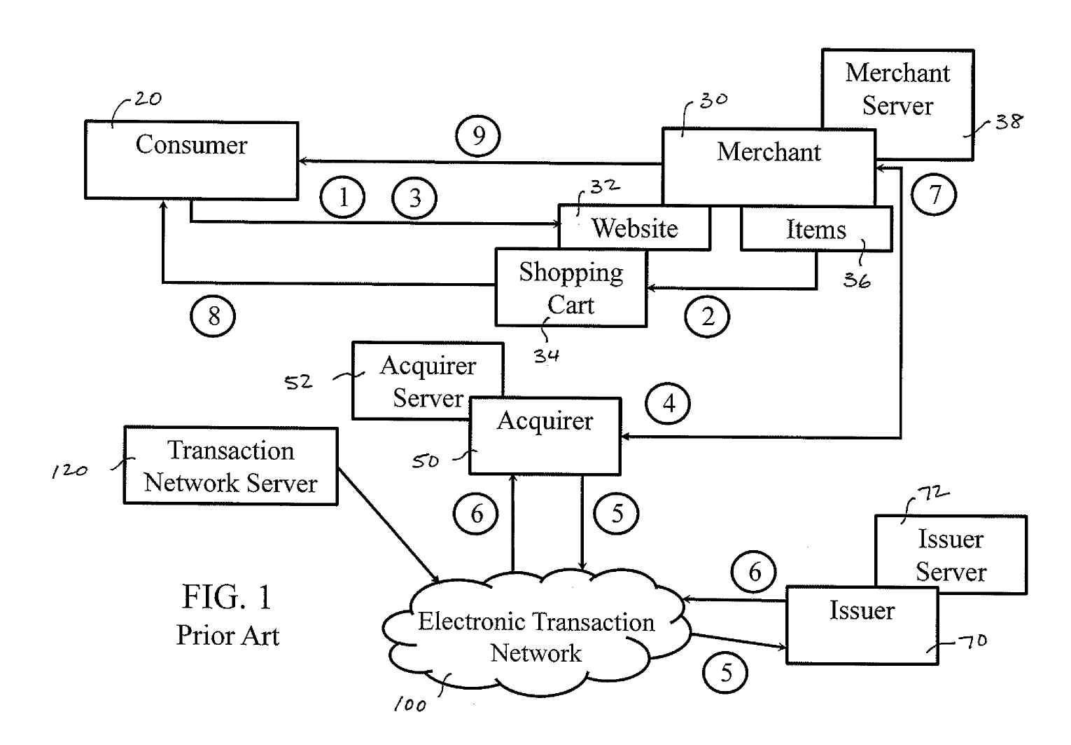

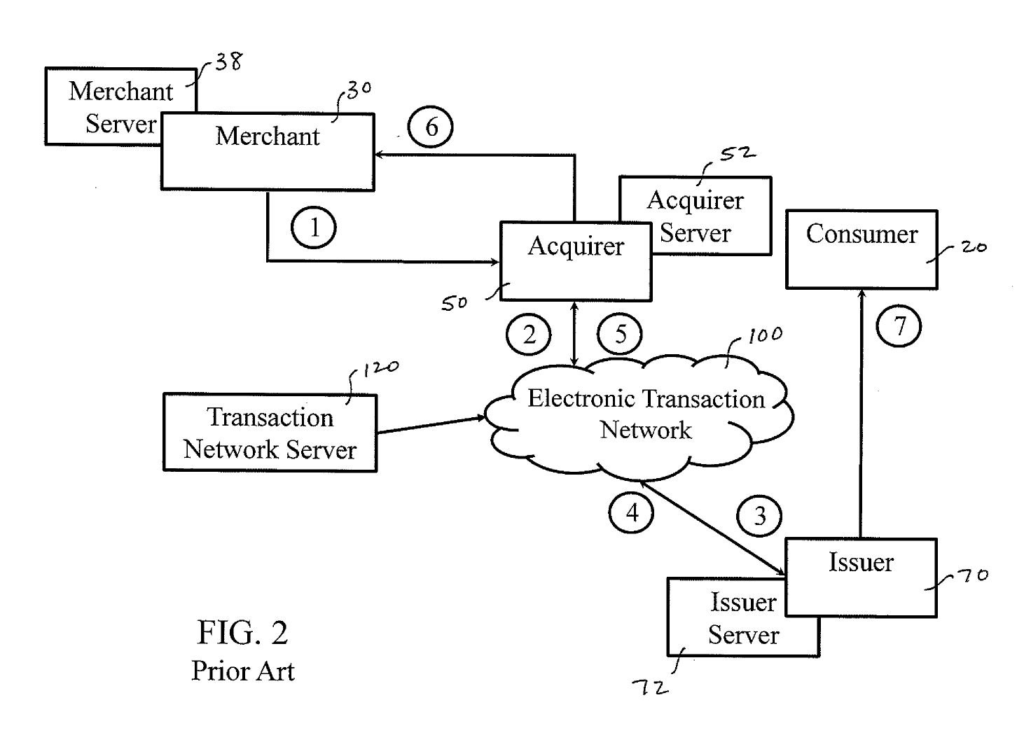

A current process for digital commerce is depicted in FIGS. 1 and 2. This process typically entails a consumer browsing items on merchant's e-commerce site or app, selecting items and adding them to a cart or bag, and then checking out. This part of the current digital commerce process requires that the consumer enter payment information, shipping address, billing address, etc., login to merchant site, login to a payment account or digital wallet, or otherwise facilitate payment to the merchant.

A first part of the process, depicted in FIG. 1, occurs when a consumer is shopping and when the merchant fulfills the order placed by the consumer. An important part of this process is the payment authorization that occurs prior to the merchant fulfilling the order. Once the consumer proceeds to check-out, personal and payment information are entered or accessed if the consumer has an account with the merchant or a digital wallet selected for the purchase. The first step in checking out is an authorization request by the merchant to an acquirer and a payment gateway, which is then typically routed to an issuer via a payment network. The authorization process typically entrails a determination of whether the consumer has sufficient credit or account balance to pay the merchant for the items, and possibly other determinations, such as fraud scoring. The issuer receives the authorization request, conducts it authorization process and then sends a response back to the merchant with a response code indicating the transaction is either approved or denied. In addition to communicating the fate of the authorization request, the response code may also be used to define the reason why the transaction failed (e.g., insufficient credit, insufficient funds, bank link not available, suspected fraudulent transaction, etc.). If the transaction is approved, the issuer holds an authorization associated with that merchant and consumer for the approved amount. This can impact the consumer's ability to spend further (because it reduces the line of credit available or it puts a hold on a portion of the funds in a debit account). The entire process typically takes a few seconds and is conducted in real-time or near real-time during the transaction.

When the transaction is approved, the merchant receives payment or assurance of payment during the payment process, and thereafter proceeds to fulfill the order for the items purchased by the consumer. Currently, these processes are continuous, and carried-out in real-time (note payment may not be made to the merchant in real-time, but the merchant is assured that payment will be made when this transaction is cleared and funded). Based upon this, the merchant can fulfill the order with confidence of being paid.

The circled numbers in FIG. 1 represent sequential steps of the process. To begin the process, at step 1, a consumer 20 access a merchant website 32 using an electronic device such as, by way of non-limiting example, a mobile phone, tablet, hand-held computing device, computer, or any other electronic device capable of connecting to a network and transmitting and receiving any type of information. The consumer 20 shops at the merchant website 32 and selects one or more items 36 to purchase, and places the items in a shopping cart 34 at step 2. When the consumer 20 is finished shopping, he/she checks-out at step 3. At this point, the merchant 30 can identify the cost of the items and other costs associated with the transaction (e.g., taxes, shipping) to determine the total cost of the transaction. At step 4, the merchant 30 transmits an authorization request to an acquirer 50, which at step 5 transmits the authorization request to an issuer 70 via an electronic transaction network 100. The issuer determines if the transaction should be approved (e.g., whether the consumer 20 has sufficient credit if a credit account is presented by the consumer 20 to the merchant 30 for the transaction, or if the consumer 20 has sufficient funds if a direct deposit account is presented by the consumer 20 to the merchant 30 for the transaction). The issuer 70 transmits at step 6 to the acquirer 50 an approval or denial of the transaction, which is then transmitted by the acquirer 50 at step 7 to the merchant 30. If the transaction is approved, the merchant 30 fulfills the order by shipping the items to the consumer at step 8. If the transaction is denied, the merchant 30 communicates this at step 9 to the consumer 20, along with an explanation for why the transaction was denied. This process is completed in real-time during the transaction and typically takes a few seconds. Thus, the merchant 30 knows whether a transaction is authorized or denied, and will only proceed to fulfill the order in case of the former.

A second part of the process is depicted in FIG. 2 during which the merchant 30 is paid for the items 36 purchased by the consumer 20. At step 1, the merchant 30 transmits order information to the acquirer 50. This is typically transmitted in a batch process from the merchant 30 for all transactions completed in a defined time such as, for example, a day. The acquirer 50 transmits, at step 2, the order information form the merchant 30 to a transaction server 120 via an electronic transaction network 100. The transaction server 120 identifies the issuer 70 for each transaction transmitted by the merchant 30 in the batch, and transmits the applicable order information to that issuer 70 at step 3. At step 4, the issuer 70 transmits payment via the electronic transaction network 100 and the acquirer 50 (at step 5) to the merchant 30 at step 6. The issuer 70 also transmits a statement to the consumer 20 at step 7. Eventually the consumer 20 will render payment to the issuer 70 to complete the transaction.

Importantly, current digital commerce requires completion of both the shopping part and at least the authorization part before the merchant will fulfill the order and ship the items.

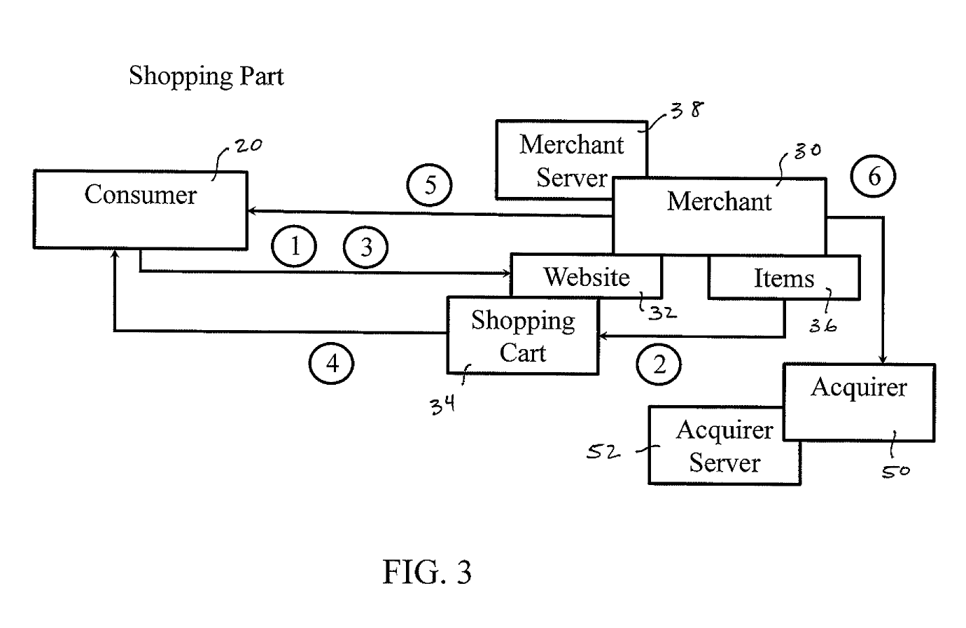

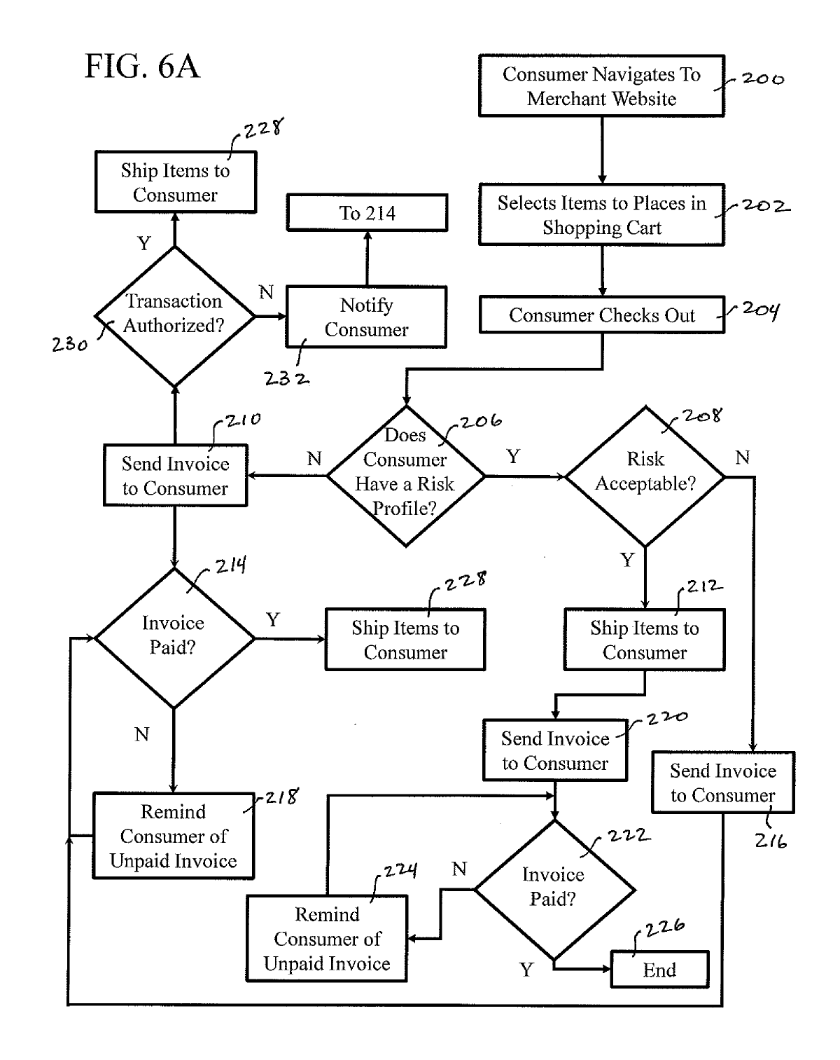

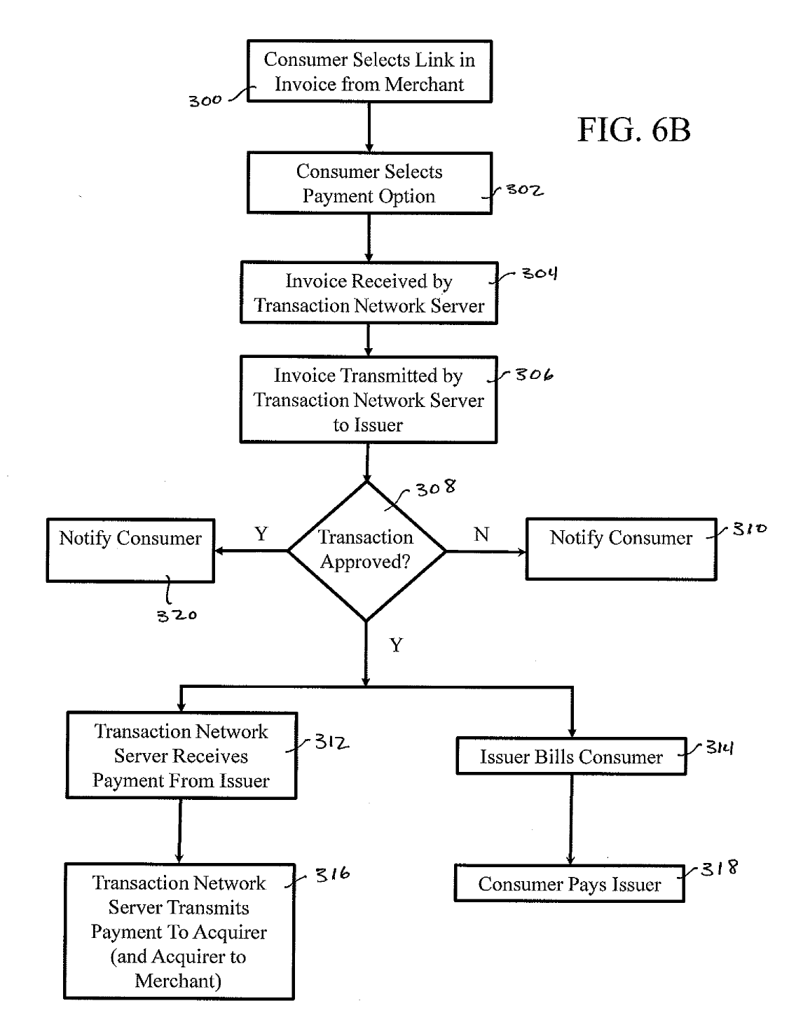

Referring next to FIGS. 3 and 6A, an embodiment of the present invention will now be discussed in more detail. A consumer 20 navigates to a merchant website 32 (e.g., electronic/mobile commerce site, application, marketplace, third party store, etc.) at step 1 and 200, and begins shopping by selecting and placing items 36 in a shopping cart 34 at step 2 and 202. When the consumer 20 is finished, he/she checks out at step 3 and 204. At this point, for a typical digital commerce transaction, the consumer is directed to a payment page via which the consumer would be prompted to enter or select a payment option, and may also be prompted for ship-to address information. Alternatively, the consumer may be presented with an option to log-in and access previously stored payment and personal information for the merchant (i.e., if the consumer has an on-line account with the merchant or a digital wallet). Typically, this information is required before the merchant fulfills and ships the items. In accordance with an embodiment of the present invention, in which the merchant has a risk profile for the consumer, the consumer completes the shopping part of the on-line transaction and the merchant fulfills the order and ships the items when the consumer checks-out. If the merchant 30 determines, at 206, that the consumer 20 has a risk profile, the merchant 30 decides, at 208, whether the risk of fulfilling this order is acceptable based upon the consumer risk profile. If the merchant 30 determines the risk is not acceptable, the merchant, at 216, will send an invoice to the consumer 20 for the items he/she wishes to purchase. The merchant 30 then monitors whether the invoice has been paid, at 214, and sends periodic reminders to the consumer 20, at 218, until it is. Once the invoice has been paid, the merchant 30 ships the items to the consumer 30 at 228. If the invoice remains unpaid, the merchant 30 will eventually cancel the order.

If, at 208, the merchant 30 determines the risk is acceptable, the merchant, at 212, ships the items to the consumer 20 at step 4.

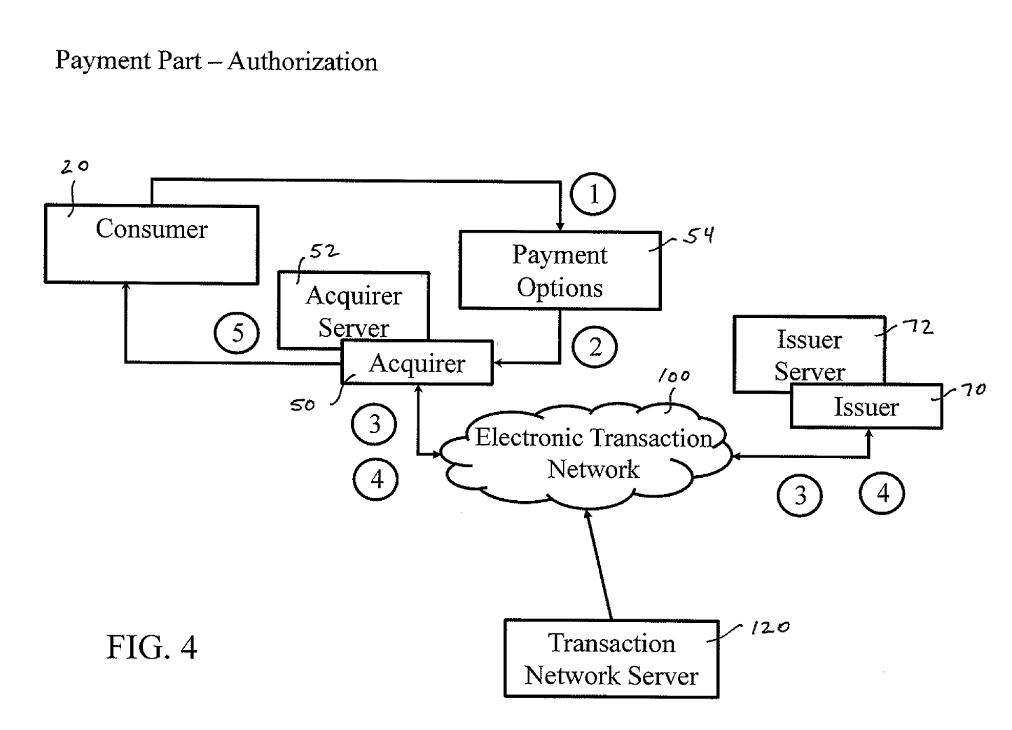

The merchant 30 also transmits to the consumer 20, at step 5 and 220, an invoice that contains details of the transaction including, by way of illustration and not limitation, a merchant identifier, an order identifier, details of the items purchased, amount of the transaction (may include taxes, shipping, and other additional costs), shipping address, etc. The merchant 30 also transmits the invoice to the acquirer 50 at step 6 of FIG. 3. The invoice transmitted to the consumer 20 contains a link which, when selected by the consumer 20 (as discussed below with reference to FIGS. 4 and 6B at step 1 of FIG. 4), will navigate the consumer 20 to a payment options web page 54 provided by the acquirer 50. The acquirer 50 thus provides a payment gateway and eliminates the need for a merchant to maintain payment options on its shopping web-site(s). This aspect of the present invention simplifies merchant shopping websites and makes digital commerce easier on the small screen of a mobile device. In addition, merchants benefit from the separation of the shopping part from payment part by allowing a payments gateway or a payment service provider to serve the different payment methods in the payment part to the consumer without the merchant web site having to integrate or incorporate each and every different payment method. This allows a merchant to accept a wide variety of payment options provided by a payments gateway or payment service provider rather than spending time and money on complex integrations of each and every payment option into the merchant website. When a consumer clicks on the link in the notification in the payment part, the link brings set of payment options offered by payment service provider or payments gateway, obviating the need for the merchant to integrate with every electronic/mobile wallet, direct bank account, card type, etc. This aspect of the present invention provides consumers and merchants with a broad range of payment options without any additional cost or effort by the merchant, resulting in higher sales and a better consumer experience. The merchant 30 monitors whether the invoice has been paid, at 222, and sends periodic reminders to the consumer 20 at 224 until it is. Once the invoice has been paid at 222, the process ends at 226.

Alternatively, the merchant 30 may not have a risk profile for the consumer 20, as determined at 206 of FIG. 6A. When the consumer 20 completes the shopping part and checks out, the merchant 30 will not fulfill the order and ship the items until at least the authorization part is completed. In this embodiment, the merchant 30 transmits an invoice to the consumer at 210, as previously described herein. If the transaction is authorized, at 230, the merchant 30 fulfills the order and ships the items at 228. If the transaction is denied, at 230, the consumer 20 is notified at 232. Even though the transaction is denied, the consumer 20 can still receive the items by paying the invoice at 214. The merchant 30 can send periodic reminders to the consumer at 218, but eventually the merchant 30 will terminate the order.

As noted previously, digital commerce transactions comprise a shopping part and a payment part. During the shopping part, the consumer selects at least one item to purchase from the merchant and places the item in a virtual shopping cart. The payment part consists of an authorization part and a clearing and settlement part. During the authorization part, the issuer determines whether to authorize or deny the transaction based upon, for example, the amount of the transaction, the consumer's credit limit or account balance, the consumer's transaction and payment history, and other factors. If a transaction is denied, the consumer will not receive the items and the merchant will not be paid. For the embodiment of the present invention in which the merchant fulfills and shops the items prior to the authorization part, the merchant assumes the risk of not being paid if the issuer denies the transaction after the merchant has already shipped the items. For the embodiment in which the merchant does not fulfill the order until after receiving an authorization, the consumer will not receive the items if the transaction is denied.

As noted previously, the present invention places control over the payment part with the consumer 20. The consumer may, at his/her convenience, initiate the authorization part of a digital commerce transaction, and does this by selecting the link, at step 1 of FIG. 4 and at 300 of FIG. 6B, received in the invoice from the merchant 30 (at step 5 of FIG. 3). As the acquirer 50 has previously received the invoice from the merchant 30 (at step 6 of FIG. 3), consumer 20 selection of the link at 300 of FIG. 6B, and further selection of a payment option at 302 and at step 2 of FIG. 4 enables the acquirer 50 to identify the issuer 70 associated with the consumer 20 and the digital commerce transaction. The transaction network server 120 receives details of the transaction from the acquirer 50, including the invoice, and transmits the invoice to the issuer 70 at step 3 of FIGS. 4 and at 304 and 306 of FIG. 6B. The issuer 70 determines, at 308 of FIG. 6B, whether to approve or deny the transaction, and returns an authorization or denial code at step 4 via the electronic transaction network 100 and transaction network server 120 to the acquirer 50. The acquirer 50 transmits directly to the consumer 20 at step 5 of FIG. 4, and at 320 or 310 of FIG. 6B, a notification indicating whether the transaction was approved or denied.

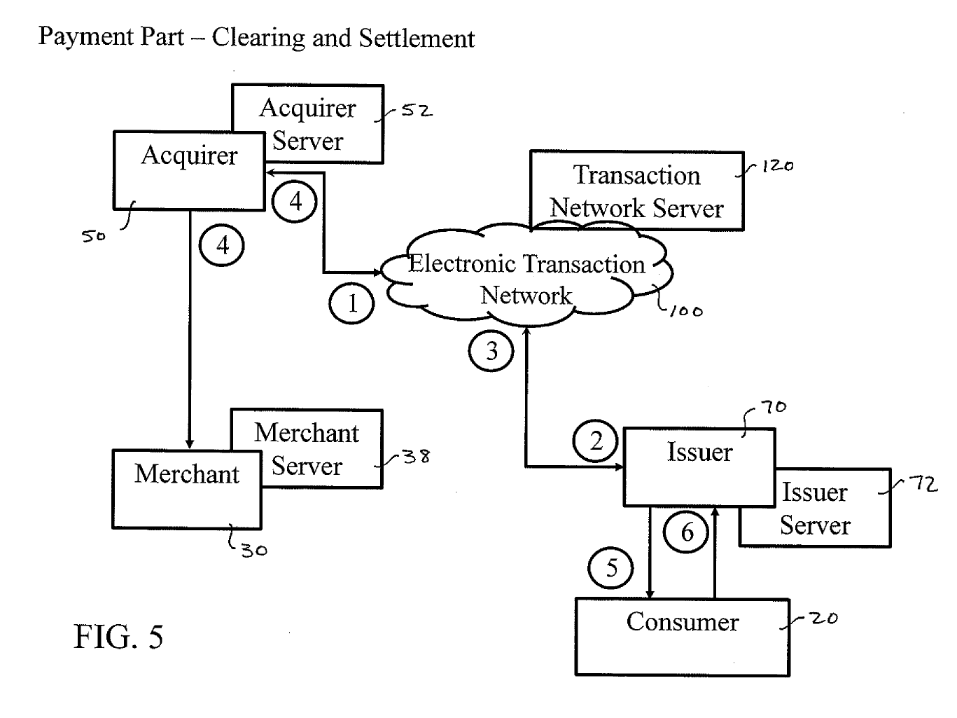

The payment part of the digital commerce transaction also includes a clearing and settlement part, depicted in FIGS. 5 and 6B. As noted above, order details, including a request for payment once a transaction is authorized or approved, are transmitted as an invoice from the merchant 30 to the acquirer 50 (at step 6 of FIG. 3), and from the acquirer 50 via the electronic transaction network 100 (and the transaction network server 120) to the issuer 70 at steps 1 and 2 of FIG. 5 and at 304 and 306 of FIG. 6B. As part of determining whether to approve or deny a transaction, the issuer 70 (i.e., the issuer server 72), upon receipt of the invoice and request for payment for authorized transactions, determines a payment amount for the order. If the transaction is approved, the issuer 70 transmits the payment amount to the transaction network server 120 at step 3 and 312 via the electronic transaction network 100. The payment amount is then transmitted by the transaction network server 120 to the acquirer 50, and by the acquirer 50 to the merchant 30, at step 4 and 316. Finally, the issuer 70 bills the consumer 20 at step 5 and 314 for transactions entered by the consumer 20, and the consumer pays the issuer at step 6 and 318.

The embodiments of the present invention described herein are carried-out by one or more servers connectable to the electronic transaction network 100 and configured to carry-out various aspects of the present invention as described herein.

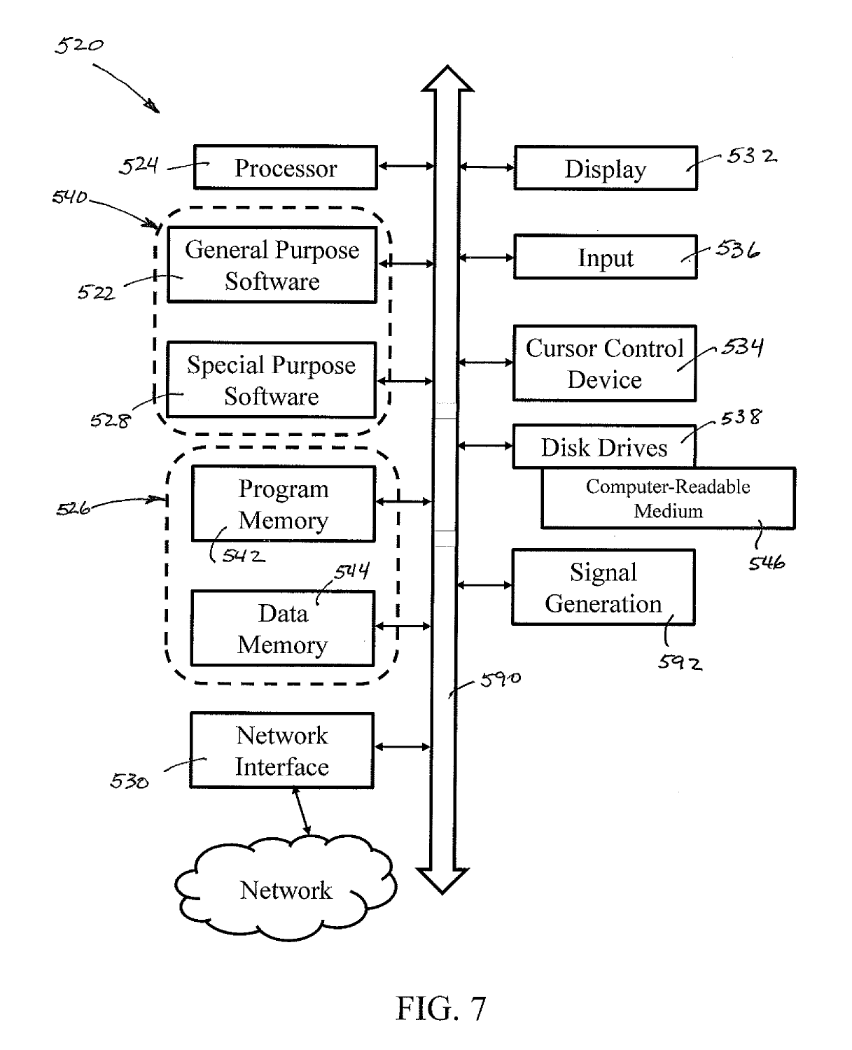

A server in accordance with embodiments of the present invention is connectable to the electronic transaction network 100 that may be any known or hereafter developed network such as, by way of illustration and not limitation, a local area network (“LAN”), wireless network, cellular network, and variations and combinations thereof. With reference to FIG. 7, the server 520 has installed and operational thereon general purpose software 522 to carry-out traditional functions of a server (see, e.g., discussion of FIG. 6, below), and special purpose software 528 to carry-out aspects of the present invention. The special purpose software 528 renders the server 520 a special purpose computing device insofar as the special purpose software 528 is operably controlling certain functions of the server 520 directed to the present invention.

With continued reference to FIGS. 1 and 7, a server 520 in accordance with embodiments of the present invention will now be discussed in more detail. The server 520 may be a general-purpose computing device having a plurality of devices and components operably connected over a bus 590. The server 520 has one or more processors 524 or central processing units (“CPU”). Although the server 520 of the present invention is discussed as having a single processor 524, a server having multiple processor, either separate or integrated in a multi-core processor, for example, are also contemplated by and within the scope and spirit of the present invention. Reference to processor in the singular herein shall be interpreted to include any variation and number of processors. The processor 524 is operable by at least one program of instructions 540 comprising general purpose software 522 to carry out functions that enable the server 520 to interface with its various hardware components (discussed further below), and to interface and communicate with other devices. The processor 524 of the present invention is also operable by at least one program of instructions 540 comprising special purpose software 528 to carry out aspects of the present invention. The general-purpose software 522 and special purpose software 528 may be stored on the server 520 in memory 526 that may comprise program memory 542 and data memory 544, or it may be stored on one or more disk drives 538 comprised of a computer-readable medium 546, or it may be stored in/on any combination of the foregoing. As used herein, the term “memory” is intended to include all currently known or hereafter developed types of permanent or temporary storage devices or components in a computing device. Exemplary memory types include, by way of illustration and not limitation, Random Access Memory (RAM)—further including Dynamic RAM (DRAM), Static RAM (SRAM), and Direct Rambus DRAM (DRDRAM), Read Only Memory (ROM)—further including Programmable ROM (PROM), erasable PROM (EPROM), and Electrically EPROM (EEPROM), cache memory, hard drives and flash memory.

The server 520 further includes a display 532, input device(s) 536, cursor control device(s) 534, signal generation device(s) 592, and network interface device(s) 530 that enable the server 520 to selectively connect to and with a network and send or receive voice, video or data, and to communicate over the network as controlled by the program of instructions 540.

The memory 526 and disk drives 538 each comprise computer-readable medium 546 that may each include a single medium or multiple media (e.g., a centralized or distributed database, and/or associated caches and servers) that store the one or more sets of instructions 540. As used herein, the term “computer-readable medium” means and includes, but is not limited to, solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives that is considered a distribution medium equivalent to a tangible storage medium. Accordingly, the embodiment is considered to include anyone or more of a tangible computer-readable medium or a tangible distribution medium, as listed herein and including art-recognized equivalents and successor media, in which the software implementations herein are stored. The term “computer-readable medium” also means and includes any medium that can store, encoding, or carrying a set of instructions in the general-purpose software 522 and in the special purpose software 528.

The system of the present invention is comprised of a plurality of servers, each having the just-described components. A merchant server 38 (as shown in FIGS. 1-3 and 5) has a program of instructions stored in memory that includes special purpose software to carry-out aspects of the present invention as described herein. This merchant special purpose software may be downloaded to the merchant server 38 from either or both of the transaction network server 120 or the issuer server 72 (as shown in FIGS. 1-5). The merchant special purpose software enables the merchant server 38 to create consumer risk profiles for one or more consumers, and to use these profiles to evaluate risk associated with fulfilling and shipping items of an order for a consumer prior to that consumer initiating and completing at least the authorization part of the digital commerce transaction. The merchant special purpose software also enables the merchant server to create a web-page via which a consumer may shop for items, place them in a virtual shopping cart, check-out, transmit a message to the consumer that includes an invoice for the order and a consumer-selectable link to initiate the payment part of the transaction. This message may be sent via e-mail, SMS text messaging, or other now known or hereafter developed ways and techniques for communicating between computing devices of any type. If there is not a risk profile for a consumer, the merchant special purpose software enables the consumer to complete the shopping part of the digital commerce transaction, and will transmit a message to the consumer that includes an invoice for the order and a consumer-selectable link to initiate the payment part of the transaction, but will not fulfill the order nor ship the items until the consumer initiates the payment part of the transaction—at a time and place decided by consumer. The merchant special purpose software also transmits order details to the acquirer server 52 (as shown in FIGS. 1-5).

A transaction network server 120 (as shown in FIGS. 1-2, 4-5) has a program of instructions stored in memory that includes special purpose software to carry-out aspects of the present invention as described herein.

An issuer server 72 has a program of instructions stored in memory that includes special purpose software to carry-out aspects of the present invention as described herein. The issuer special purpose software may be downloaded to the issuer server 72 from the transaction network server 120, or it may be originally resident on the issuer server 72. In response to consumer initiation of the payment part, the issuer special purpose software performs an authorization for the payment part of the transaction. As noted previously, this occurs upon consumer initiation of the payment part and after completion of the shopping part. In an embodiment, this may also occur after the merchant had fulfilled and shipped the items. In performing the authorization, the issuer special purpose software receives the order for the transaction, performs an authorization to determine whether to approve the order, and transmits the determination of either approval or denial to the transaction network server 120. The issuer special purpose software also ensures payment to the merchant. The issuer special purpose software receives a request for payment from the transaction network server 120, determines a payment amount by considering the total cost of the items that comprise the order, including any taxes, shipping or other costs, and also considering costs associated with processing electronic transactions over the electronic transaction network 100. The issuer special purpose software then transmits the payment amount to the transaction network server 120 for transmission to the merchant.

An acquirer server 52 has a program of instructions stored in memory that includes special purpose software to carry-out aspects of the present invention as described herein. The acquirer special purpose software may be downloaded to the acquirer server 52 from either or both of the transaction network server 120 and the issuer server 72. The acquirer special purpose software provides, in response to consumer selection of the link and initiation of the payment part, a payment option web page having a plurality of payment options selectable by the consumer. These options include, by way of illustration and not limitation, payment using a credit or debit card, bank account, digital wallet, or other now known or hereafter developed electronic payment methods, means and techniques. The acquirer special purpose software, in response to consumer selection of one of the plurality of payment options, transmits either or both of an authorization request and a payment request to the issuer server.

Although the present specification may describe components and functions implemented in the embodiments with reference to particular standards and protocols, the disclosed embodiments are not limited to such standards and protocols.

In accordance with various embodiments, the present invention may be implemented as one or more software programs running on one or more computing devices and one or more computer processors. Dedicated hardware implementations including, but not limited to, application specific integrated circuits, programmable logic arrays and other hardware devices can likewise be constructed to implement the present invention. Furthermore, alternative software implementations including, but not limited to, distributed processing or component/object distributed processing, parallel processing, or virtual machine processing can also be constructed to implement the present invention.

Modifications to embodiments of the present invention are possible without departing from the scope of the invention as defined by the accompanying claims. Expressions such as “including,” “comprising,” “incorporating,” “consisting of,” “have,” “is,” used to describe and claim the present invention are intended to be construed in a non-exclusive manner, namely allowing for articles, components or elements not explicitly described herein also to be present. Reference to the singular is to be construed to relate to the plural, where applicable.

Although specific example embodiments have been described, it will be evident that various modifications and changes may be made to these embodiments without departing from the broader scope of the inventive subject matter described herein. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A system for an improved electronic transaction between a consumer and a merchant over an electronic transaction network, the electronic transaction having a shopping part during which the consumer selects at least one item to purchase from the merchant and during which the merchant creates an order for the electronic transaction, and a payment part initiable by the consumer temporally separate from the shopping part, the system comprising:
a merchant server connectable to the electronic transaction network and having a consumer risk profile stored in memory of the merchant server and a processor operable by a program of instructions stored in memory of the merchant server that causes the merchant server processor to, prior to consumer initiation of the payment part;
determine, based upon the consumer risk profile, whether to fulfill the order and ship the at least one item prior to customer initiation of the payment part;
transmit the order to an acquirer server; and
transmit an invoice for the order to the consumer, the invoice containing a link selectable by the consumer for consumer initiation of the payment part; and
an issuer server connectable to the electronic transaction network and having a processor operable by a program of instructions stored in memory of the issuer server that causes the issuer server processor to, in response to consumer initiation of the payment part;
receive the order;
determine whether to approve the order; and
transmit the determination to a transaction network server.

2. The system according to claim 1, wherein the program of instructions, when executed by the issuer server processor, further causes the issuer server processor to, in response to consumer initiation of the payment part:
receive a request for payment of the order from the transaction network server;
determine a payment amount; and
transmit the payment amount to the transaction network server for transmission to the merchant for the electronic transaction.

3. The system according to claim 1, wherein the consumer risk profile is based upon historical shopping data for electronic transactions between the consumer and the merchant.

4. The system according to claim 1, wherein the consumer risk profile is based upon historical shopping data for electronic transactions between the merchant and one or more consumers.

5. The system according to claim 1, wherein the consumer risk profile is based upon a geographic location of one of the merchant and the consumer.

6. The system according to claim 1, wherein the order contains at least one of a merchant identifier, an order identifier, an item identifier, a transaction amount and a ship-to address.

7. The system according to claim 1, wherein consumer selection of the link in the invoice causes initiation of the payment part, wherein the system further comprises an acquirer server having a processor operable by a program of instructions stored in memory of the acquirer server that causes the acquirer server processor to, in response to consumer selection of the link and initiation of the payment part, provide a payment option web page to the consumer having a plurality of payment options selectable by the consumer.

8. The system according to claim 7, wherein the program of instructions, when executed by the acquirer server processor, further causes the acquirer server processor to, in response to consumer selection of one of the plurality of payment options, transmit an authorization request to the issuer server.

9. The system according to claim 7, wherein the program of instructions, when executed by the acquirer server processor, further causes the acquirer server processor to, in response to consumer selection of one of the plurality of payment options, transmit a payment request to the issuer server.

10. The system according to claim 7, wherein the program of instructions, when executed by the acquirer server processor, further causes the acquirer server processor to, in response to consumer selection of one of the plurality of payment options, transmit an authorization request and a payment request to the issuer server.

11. A system for an improved electronic transaction between a consumer and a merchant over an electronic transaction network, the electronic transaction having a shopping part during which the consumer selects at least one item to purchase from the merchant and during which the merchant creates an order for the electronic transaction, and a payment part initiable by the consumer temporally separate from the shopping part, a merchant server, an issuer server and an acquirer server being connectable to the electronic transaction network, the system comprising:
a transaction network server having a processor operable by a program of instructions stored in memory of the transaction network server that causes the transaction network server processor to, in response to consumer initiation of the payment part by selection of a link in an invoice received by the consumer from the merchant server and;
receive the invoice from the acquirer server;
transmit the invoice to the issuer server;
receive a determination from the issuer server of whether to approve the invoice;
transmit the determination to the acquirer server;
receive a request for payment of the invoice of a payment amount from the issuer server; and
transmit the payment amount to the acquirer server for transmission to the merchant server.

12. A method for improving an electronic transaction between a consumer and a merchant over an electronic transaction network, the electronic transaction having a shopping part during which the consumer selects at least one item to purchase from the merchant and during which the merchant creates an order for the electronic transaction, and a payment part initiable by the consumer temporally separate from the shopping part, the method comprising, prior to consumer initiation of the payment part and by a merchant server connectable to the electronic transaction network and having a consumer risk profile stored in memory of the merchant server:
determining, based upon the consumer risk profile, whether to fulfill the order and ship the at least one item prior to customer initiation of the payment part;
transmitting the order to an acquirer server; and
transmitting an invoice for the order to the consumer, the invoice containing a link selectable by the consumer for consumer initiation of the payment part;
the method further comprising, in response to consumer initiation of the payment part and by an issuer server connectable to the electronic transaction network;
receiving the order;
determining whether to approve the order; and
transmitting the determination to a transaction network server.

13. The method according to claim 12, the method further comprising, in response to consumer initiation of the payment part and by the issuer server:
receiving a request for payment of the order from the transaction network server;
determining a payment amount; and
transmitting the payment amount to the transaction network server for transmission to the merchant for the electronic transaction.

14. The method according to claim 12, wherein the consumer risk profile is based upon historical shopping data for electronic transactions between the consumer and the merchant.

15. The method according to claim 12, wherein the consumer risk profile is based upon historical shopping data for electronic transactions between the merchant and one or more consumers.

16. The method according to claim 12, wherein the consumer risk profile is based upon a geographic location of one of the merchant and the consumer.

17. The method according to claim 12, wherein the order contains at least one of a merchant identifier, an order identifier, an item identifier, a transaction amount and a ship-to address.

18. The method according to claim 12, wherein consumer selection of the link in the invoice causes initiation of the payment part, wherein the method further comprises, in response to consumer selection of the link and initiation of the payment part and by an acquirer server, providing a payment option web page to the consumer having a plurality of payment options selectable by the consumer.

19. The method according to claim 18, wherein the method further comprises, in response to consumer selection of one of the plurality of payment options and by the acquirer server, transmitting an authorization request to the issuer server.

20. The method according to claim 18, wherein the method further comprises, in response to consumer selection of one of the plurality of payment options and by the acquirer server, transmitting a payment request to the issuer server.

21. The method according to claim 18, wherein the method further comprises, in response to consumer selection of one of the plurality of payment options and by the acquirer server, transmitting an authorization request and a payment request to the issuer server.

22. A method for an improving an electronic transaction between a consumer and a merchant over an electronic transaction network, the electronic transaction having a shopping part during which the consumer selects at least one item to purchase from the merchant and during which the merchant creates an order for the electronic transaction, and a payment part initiable by the consumer temporally separate from the shopping part, the method comprising, in response to consumer initiation of the payment part by consumer selection of a link in an invoice for the order and by a transaction network server in the electronic transaction network:
receiving the invoice from an acquirer server;
transmitting the invoice to an issuer server;
receiving a determination from the issuer server of whether to approve the invoice;
transmitting the determination to the acquirer server;
receiving a request for payment of the invoice of a payment amount from the issuer server; and
transmitting the payment amount to the acquirer server for transmission to the merchant server.
